(19) United States
(12) Patent Application Publication
(10) Pub. No.: US 2025/0340000 A1
(43) Pub. Date: Nov. 6, 2025

(54) GATE INSERT FOR INJECTION MOLDING

(71) Applicant: PROGRESSIVE COMPONENTS INTERNATIONAL CORPORATION, WAUCONDA, IL (US)

(72) Inventors: Glenn STARKEY, Wauconda, IL (US); Sebastian JURCZAK, Wauconda, IL (US); James FATTORI, Trevose, PA (US)

(73) Assignee: PROGRESSIVE COMPONENTS INTERNATIONAL CORPORATION, WAUCONDA, IL (US)

(21) Appl. No.: 18/655,476

(22) Filed: May 6, 2024

(51) Int. Cl. B29C 45/27; B29C 45/26

(52) U.S. Cl. CPC B29C 45/2711; B29C 45/2673

(57) ABSTRACT

A gate insert for an injection mold and method of use. The gate insert includes a gate insert body with a fastener seat extending from a side of the gate insert body. A clamp block sets on the fastener seat, and a tapered fastener extends through the clamp body and fastener seat to secure the gate insert to a mold. Spacers are used to provide for machining of the insert cavity face to adjust a gate opening.

### BACKGROUND OF THE INVENTION

This invention relates generally to injection molding and, more particularly, to a gate insert for an injection molding operation.

During injection molding a molten plastic travels through channels called sprues and runners until reaching a gate. The gate is an opening that allows the plastic to enter the mold cavity. An important aspect of the mold design is where and how the mold is gated. If the gate is too small, material pressure can build and cause the plastic to be squeezed into the cavity too quickly. Material pressure changes are generally not optimal, resulting in out of tolerance parts being molded.

Mold builders commonly design gate inserts into molds where it is anticipated that an abrasive material in the molding material will open up the gate over time. Using gate inserts allows for replacement of the gate geometry as needed, and also allows for a trial-and-error machining of the gate insert to determine the best gate opening. When designing a gate insert for molds with abrasive materials, there are generally two scenarios: 1) where a similar mold has been designed and built before, so the initial gate design for the new mold is known, and will likely not need adjustment during mold sampling; and 2) with a new part altogether, a steel safe undersized gate will be what is first tried, and there may be two or more attempts at reaching the correct gate sizing for optimal processing.

There is a continuing need to improve the providing of optimal gate geometry for optimal processing by molders.

### SUMMARY OF THE INVENTION

A general object of the invention is to provide a compact, off-the-shelf standard gate insert for when abrasive materials open gates. The compact design provided by this invention is serviceable from the parting line and provides an option to adjust gate size while the mold remains in the press.

The general object of the invention can be attained, at least in part, through a gate insert for an injection mold. The gate insert including a gate insert body, wherein the gate insert body includes or is machinable to include a gate for delivering plastic material into the mold. A fastener seat extends laterally from the gate insert body and includes a first fastener opening. A clamp block including a second fastener opening sets on the fastener seat. A fastener extends through the clamp block and the fastener seat, into a threaded opening in the mold.

In embodiments, a top surface of the clamp block is flush with, or just below, a top surface of the gate insert body when the clamp block is seated on the fastener seat. The clamp block desirably includes a tapered recess matching, and configured to receive, a tapered head of the fastener. Thus the top surface of each of the clamp block and the fastener is desirably flush with or below a top surface of the gate insert body when the clamp block is fastened to the fastener seat.

In embodiments of the invention, the gate insert is adjustable, such as through machining a front face to widen a gate opening. A removeable spacer can be used and sized to fit against a surface of the gate insert body opposite the injection mold. The spacer includes a foot extension configured to fit in a slot at a bottom surface of the gate insert body, whereby the spacer is clamped in place via the fastener. A second spacer having a greater thickness than and interchangeable with the removeable spacer is used to adjust for machining of the gate insert front face. The first fastener opening can be an adjustable slot that allows for moving the gate insert closer to the mold after machining the front face. The first fastener opening can include more than one tap for receiving the fastener in more than one position.

The invention further includes a gate insert including a gate insert body having a front for facing the injection mold cavity, a back opposite the front surface, and a side extending between the front and the back. A fastener seat extends from the side of the gate insert body and includes a top surface with a first fastener opening. A clamp block includes a second fastener opening and is configured to seat on the top surface of the fastener seat. A fastener is configured to extend through the clamp block and the fastener seat. A removeable spacer is adjacent to the back surface of the gate insert body.

The invention further includes a method of sampling or qualifying an injection mold. The method includes steps of: inserting the gate insert into the injection mold, for an initial trial run; machining an amount of the gate insert off the front of the gate insert to enlarge a gate opening; and replacing the spacer with a second spacer corresponding to the amount removed by the machining, for a second trial run.

Other objects and advantages will be apparent to those skilled in the art from the following detailed description taken in conjunction with the appended claims and drawings.

### BRIEF DESCRIPTION OF THE DRA WINGS

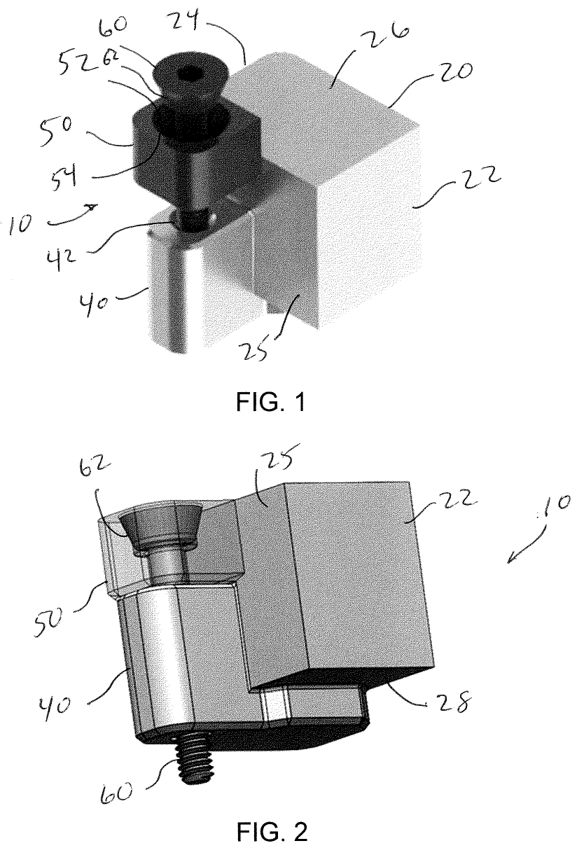

FIG. 1 is an exploded view of a gate insert according to one embodiment of this invention.

FIG. 2 is a side perspective view of the gate insert of FIG. 1.

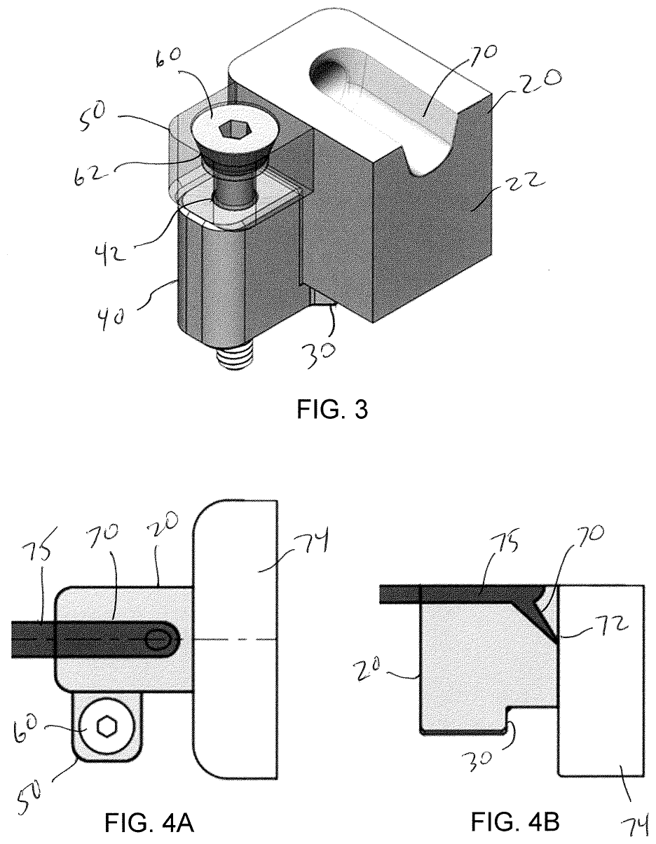

FIG. 3 shows a perspective view of the gate insert of FIG. 1 with a gate added thereto.

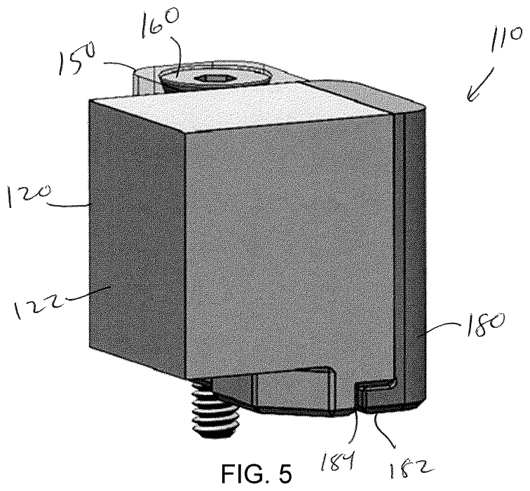

FIGS. 4A and 4B representatively show the use of a gate insert to pass plastic to a mold.

FIG. 5 shows a gate insert according to one embodiment of this invention.

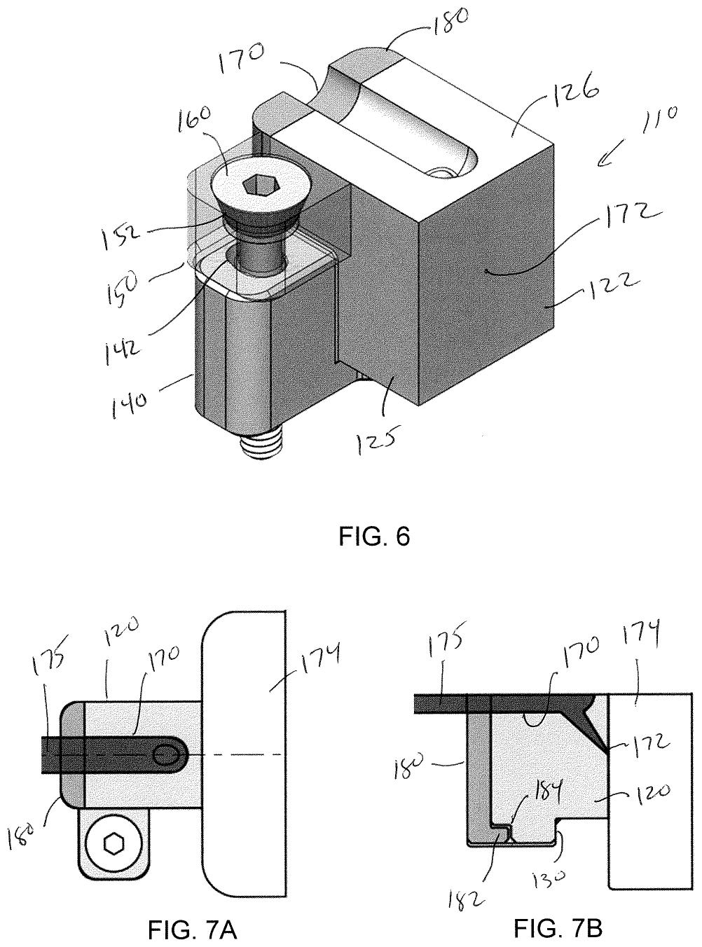

FIG. 6 shows a perspective view of the gate insert of FIG. 5 with a gate added thereto.

FIGS. 7A and 7B representatively show the use of a gate insert of one embodiment of this invention to pass plastic to a mold.

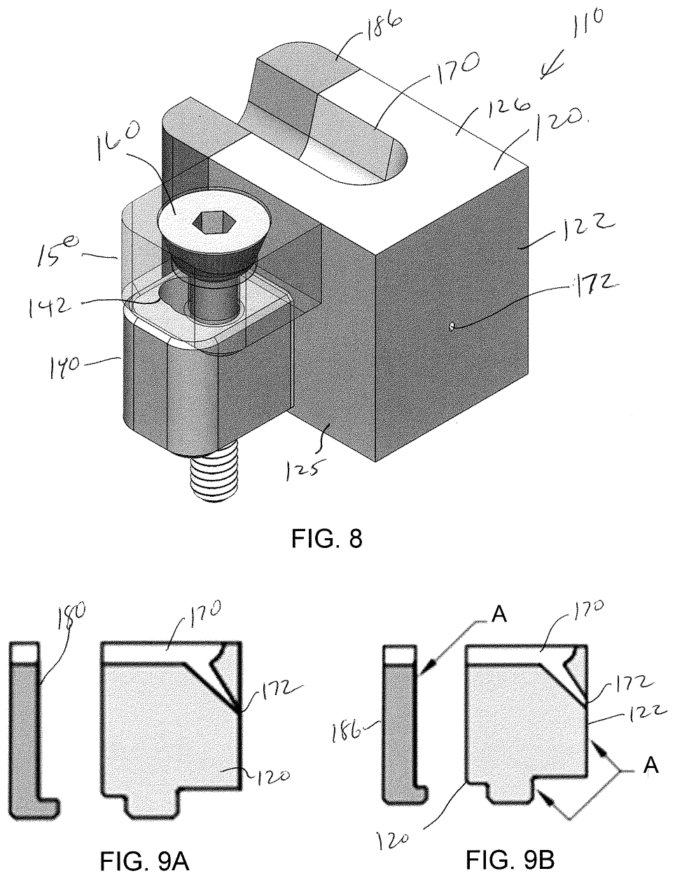

FIG. 8 shows a perspective view of the gate insert of FIG. 5 with a different spacer applied.

FIGS. 9A and 9B representatively show the use of a gate insert with two different spacers.

### DETAILED DESCRIPTION OF THE INVENTION

The present invention provides a gate insert for injection molding. The gate inserts of this invention are particularly useful when using abrasive molding materials, which are known to widen the gate upon over time. The insert can be removed from the sprue/runner channels and replaced with a new insert having the desired opening size. This can generally be done without dismantling the entire mold.

FIGS. 1 and 2 show a gate insert 10 according to one embodiment of this invention. A gate insert body 20 includes a front surface 22 for facing a mold, a back surface 24 opposite the front surface 22, a top surface 26, a bottom surface 28, and a side surface 25 extending between the front and back surfaces and the top and bottom surfaces. The bottom surface 28 further includes a heel extension 30 which can reduce shifting due to mold pressures.

A fastener seat 40 extends laterally from the gate insert body 20 and includes a first fastener opening 42. The fastener seat 40 is designed to receive a clamp block 50 thereon. The clamp block 50 includes a second fastener opening 52 that aligns with the first fastener opening 40 to collectively receive fastener 60. Fastener 60 extends through the clamp block 50 and the fastener seat 40 into a threaded opening in a corresponding mold surface, to secure the gate insert in place on the mold.

In the illustrated embodiments, the fastener 60 has a tapered head 62 and the second fastener opening 52 has a matching tapered surface 54, preferably forming a sealed fit. As illustrated in FIGS. 2 and 3, the top of the fastener 60 and the top surface of the clamp block 50 are preferably flush with each other and with, or just slightly below, the top surface 26 of the insert body 20. The fastener 60 can be any suitable bolt or equivalent, such as a partially threaded bolt or a shoulder bolt. The fastener can be vertical as shown, or at an angle to the gate insert.

A common objection to bolting an element to a mold parting line, is that sometimes an operator inadvertently ‘flashes’ the mold, and that plastic flash works its way into every nook and cranny, and is difficult to chip out using a screwdriver, hammer, and/or blow torch. Embodiments of this invention respond to this issue with a custom fastener 60 where the screw head plus all details around the screw head are sealed, such as by a precise, tapered fit. The hex tool opening in the fastener 60 has a draft angle of 1-3 degrees, and preferably about 2 degrees to allow the plastic to be released by hand, without needing any chipping away at it.

In embodiments of this invention, the gate insert 20 starts as a “blank” with a gate insert body 20 as shown in FIGS. 1 and 2. As represented in FIG. 3, the manufacturer or the end user (e.g., mold maker) machines the desired gate 70 into the insert. FIGS. 4A-B show a representative flowing of a plastic material 75 through the gate 70, which tapers to a gate opening 72, and then into mold 74.

Various sizes, shapes, and configurations are available for the gate insert and the individual components, depending on need. Likewise, various materials are available for the components. In embodiments the clamp block is formed of a black oxide material.

The gate insert of FIGS. 1-3 is designed for use when an intended gate size is known. The invention further include a gate insert designed for use in applications where the gate opening size is unknown and adjustments are likely. Rather than re-machining (e.g., using electrical discharge machining (EDM)) the gate to open the diameter, material can be removed from the front surface/cavity face of the gate insert. Spacers are provided separately to keep the overall gate insert size correct relative to the mold.

FIG. 5 shows a “blank” gate insert 110 for an unknown gate geometry, where adjustment to the gate opening is likely during sampling or qualifying the mold. FIG. 6 shows the gate insert 120 with a machined gate 170 and gate opening 172.

The gate insert 110 includes a gate insert body 120 with a front surface 122, a back surface 124 opposite the front surface 122, a top surface 126, a bottom surface 128, and a side surface 125 extending between the front and back surfaces and the top and bottom surfaces. The gate insert further includes a fastener seat 140 with a first fastener opening 142, and a clamp block 150 with a second fastener opening 152 that aligns with the first fastener opening 140 to receive fastener 160.

The gate insert 110 further includes a separate and removeable spacer 180 adjacent to the back surface 124. The spacer 180 has a general shape and/or periphery to match the back surface 124. The spacer 180 includes a foot extension 182 that is designed to fit into a slot 184 in the back and bottom surfaces of the insert body 120. The foot extension 182 is thus clamped down and in place by the tightening of the fastener 160 relative to the mold. As shown in FIG. 6, the gate 170 is machined through the spacer 180 as well. FIGS. 7A and 7B illustrate plastic material 175 flowing across the spacer 180 and the insert body 120 through gate opening 172 and into mold 174.

As mentioned, the gate insert 110 allows for improved adjustment to the gate opening 172. If a mold builder is sampling or qualifying the mold, the builder likely does not have access to EDM capabilities, and thus delays will occur when outsourcing for each gate adjustment. The adjustable gate insert provides a same pocket size as shown in FIG. 1, providing the same parting line removability, etc. In the embodiment of FIGS. 5 and 6, an initial spacer (or shim) is provided. At least a second adjustment spacer is also provided.

To open up the gate, the user does not re-machine or re-EDM the gate. Instead the user enlarges the gate opening 172 by grinding the front face 122 of the insert 120 (e.g., removing 0.020″). As the gate 170 is tapered from the opening 172, the opening is now enlarged. A same amount is removed from the bottom heel front surface 130 if present. The stock spacer 180 is removed and replaced by a second spacer 186 shown in FIG. 8, having a different width equal to the original spacer 180 plus the amount removed from the front face 120. The mold can be run again to test the gate opening 172. If further enlargement of the gate opening 172 is needed, the user removes the gate insert 110 from the mold, and removes another, for example, 0.010″ from the front 122 and heel 130, and then use a new spacer of the appropriate width. It is anticipated that the user will have several spacers, such as in a kit of different sizes, or which can be machined from a wider dimension down to the needed dimension.

FIG. 9A generally illustrates the original spacer 180 and FIG. 9B shows the surfaces A machined to open the gate opening 172. As an example, the spacer 180 has a relevant thickness or width of 0.175 inch and spacer 186 has a width of 0.235 inch, a difference of 0.06 inch. If 0.02 inch is removed from the surfaces of the front face 122 shown in FIG. 9B, then 0.04 is removed from the face of spacer 186 to provide the original width dimension of the insert 110.

By machining the front face 122, the insert 110 will need to be moved closer to the mold. As illustrated in FIGS. 6 and 8, ‘travel’ is provided by an elongated or slot-style fastener opening 140 in the fastener seat 172. In embodiments, the slot opening 140 may have a plurality of tap seats, coordinated to common grinding distances, to further help secure the insert 110 in place. The tap seats can be sized to a shoulder of the bolt or to a jack screw.

Thus, the invention provides a gate insert that allows for adjustability and easier machining and qualification by the mold user. The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An insert for an injection mold, the insert comprising:
a gate insert body, wherein the gate insert body includes or is machinable to include a gate for delivering plastic material into the mold;
a fastener seat extending laterally from the gate insert body and including a first fastener opening;
a clamp block including a second fastener opening; and
a fastener configured to extend through the clamp block and the fastener seat.

2. The insert of claim 1, wherein a top surface of the clamp block is flush with a top surface of the gate insert body when the clamp block is seated on the fastener seat.

3. The insert of claim 1, wherein the clamp block includes a tapered recess matching a tapered head of the fastener.

4. The insert of claim 3, wherein a top surface of each of the clamp block and the fastener is flush with or below a top surface of the gate insert body when the clamp block is fastened to the fastener seat.

5. The insert of claim 1, wherein the gate insert body comprises a lower heel extension.

6. The insert of claim 1, further comprising a removeable spacer sized to fit against a surface of the gate insert body opposite the injection mold.

7. The insert of claim 6, wherein the spacer includes a foot extension configured to fit in a slot at a bottom surface of the gate insert body.

8. The insert of claim 6, further comprising a second spacer having a greater thickness than and interchangeable with the removeable spacer.

9. The insert of claim 6, wherein the first fastener opening is an adjustable slot including more than one tap for receiving the fastener in more than one position.

10. The insert of claim 1, wherein the gate insert body includes a first surface facing the injection mold and a second surface opposite the first, and further comprising a spacer sized to fit against the second surface.

11. An insert for an injection mold, the insert comprising:
a gate insert body having a front for facing the injection mold cavity, a back opposite the front surface, and a side extending between the front and the back;
a fastener seat extending from the side of the gate insert body and including a top surface with a first fastener opening;
a clamp block including a second fastener opening and configured to seat on the top surface of the fastener seat;
a fastener configured to extend through the clamp block and the fastener seat; and
a removeable spacer adjacent to the back surface of the gate insert body.

12. The insert of claim 11, wherein the spacer comprises a foot extension configured to fit in a slot at a bottom surface of the gate insert body.

13. The insert of claim 11, further comprising a second spacer having a greater thickness than and interchangeable with the removeable spacer.

14. The insert of claim 11, wherein the first fastener opening is an adjustable slot including more than one tap for receiving the fastener in more than one position.

15. The insert of claim 14, wherein the fastener is a partially threaded shoulder bolt having a tapered head.

16. The insert of claim 15, wherein a top surface of the clamp block is flush with a top surface of the gate insert body when the clamp block is seated on the fastener seat.

17. The insert of claim 15, wherein the clamp block includes a tapered recess matching a tapered head of the fastener.

18. A method of qualifying an injection mold, the method comprising:
inserting the insert of claim 11 into the injection mold;
machining an amount of the insert off the front of the insert to enlarge a gate opening;
replacing the spacer with a second spacer corresponding to the amount removed by the machining.
